(19) United States
(12) Patent Application Publication
(10) Pub. No.: US 2010/0083130 A1
(43) Pub. Date: Apr. 1, 2010

(54) COMPUTER PRODUCT, CONTENT PROVIDING APPARATUS, AND CONTENT PROVIDING METHOD

(75) Inventor: Nao OI, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/630,240

(22) Filed: Dec. 3, 2009

Related U.S. Application Data
(63) Continuation of application No. PCT/JP2007/061390, filed on Jun. 5, 2007.

(51) Int. Cl. G06F 3/01

(52) U.S. Cl. 715/744

(57) ABSTRACT

A computer-readable recording medium stores therein a content providing program of a content providing system that provides content of a presentation to a participant terminal. The content providing program causes the content providing system to execute acquiring attribute information concerning an attribute of a participant using the participant terminal; extracting, based on the attribute information, content stored in a content database and corresponding to the attribute information; and transmitting to the participant terminal, based on a page-turning instruction for the content, page information of the content to be displayed on a display screen of the participant terminal.

### FIELD

The embodiment discussed herein is related to a computer product, content providing apparatus, and content providing method.

### BACKGROUND

A presentation for explaining insurance products to a multiplicity of customers all at once commonly involves the use of brochures providing product information, a screen displaying the product information, etc. Because the contents of insurance products differ according to customer attributes, such as age and gender, the presentation is often carried out using a model pattern typifying a person having common customer attributes.

In a conventional presentation, a terminal may be prepared for each participant enabling the participants to input attributes (age and gender) into the terminal so that a server is able to distribute details conforming to the attributes of each participant. For example, according to a disclosed technique, when a transmission origin IP address included in a Web page browsing request corresponds to a given IP address, the user is guided to a Web page that includes employment information corresponding to an attribute indicative of an institution to which the user's device (preliminarily correlated with the given IP address) belongs (see, e.g., Japanese Laid-Open Patent Publication No. 2002-24277).

For example, another prior technique has been disclosed, in which provided information that corresponds to user attributes are divided by tags and the information is processed separately according to each user attribute to provide information according to user attribute (see, e.g., Japanese Laid-Open Patent Publication No. 2001-16202).

According to the above conventional techniques, however, information explaining a model pattern is provided uniformly to each participant at the presentation despite the participants having a variety of attributes and poses a problem in that a participant whose attributes, such as age and gender, do not match the model pattern is not able to understand the contents of the presentation or does not find the presentation relevant.

Another form of implementing a presentation may be such that the attributes of participants are collected in advance to distribute to terminals allocated respectively to the participants, information corresponding to the attributes (the information being distributed in advance and via a network), thereby providing an opportunity for the participants to understand the contents of the explanation prior to the presentation. This form of presentation, however, has a problem in that the collection of customer attributes for insurance products, etc., in advance is difficult.

### SUMMARY

According to an aspect of an embodiment, a computer-readable recording medium stores therein a content providing program of a content providing system that provides content of a presentation to a participant terminal. The content providing program causes the content providing system to execute acquiring attribute information concerning an attribute of a participant using the participant terminal; extracting, based on the attribute information, content stored in a content database and corresponding to the attribute information; and transmitting to the participant terminal, based on a page-turning instruction for the content, page information of the content to be displayed on a display screen of the participant terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of a configuration of a content providing system that includes a content providing apparatus according to an embodiment;

FIG. 2 is an explanatory diagram of a configuration of an electronic paper managing system;

FIG. 3 is an external view of a content providing apparatus according to the embodiment;

FIG. 4 is an explanatory diagram of a functional configuration of the content providing apparatus;

FIG. 5 is a flowchart (1) of an example of a participant attribute information acquiring/grouping process;

FIG. 6 is an explanatory diagram of an example of a screen displayed by a personal computer (PC);

FIG. 7 is an explanatory diagram of the contents of a participant attribute grouping table;

FIG. 8 is a flowchart of an example of a grouping participant attribute-greatest-in-number identifying process;

FIG. 9 is an explanatory diagram of the contents of a participant attribute totaling table;

FIG. 10 is a flowchart (1) of an example of content-tied display processing;

FIG. 11 is an explanatory diagram of the contents of a detail page number database (DB);

FIG. 12 is an explanatory diagram of the contents of a participant attribute-type-based content DB;

FIG. 13 is an explanatory diagram of the contents of a detail content information DB;

FIGS. 14A to 14C depict examples of display screens;

FIG. 15 is a flowchart (2) of another example of the participant attribute information acquiring/grouping process;

FIG. 16 is an explanatory diagram of the contents of an electronic paper writer managing DB;

FIG. 17 is a flowchart (2) of another example of the content-tied display processing;

FIG. 18 is a flowchart (1) of an example of a participant attribute information acquiring/accumulating process;

FIG. 19 is an explanatory diagram of the contents of a participant terminal ID/attribute associated table;

FIG. 20 is a flowchart of an example of processing for identifying the participant attribute greatest-in-number;

FIG. 21 is an explanatory diagram of the contents of a participant attribute greatest in number table;

FIG. 22 is a flowchart (3) of another example of the content-tied display processing;

FIG. 23 is a flowchart (2) of another example of the participant attribute information acquiring/accumulating process; and

FIG. 24 is a flowchart (4) of another example of the content-tied display processing.

### DESCRIPTION OF EMBODIMENTS

Preferred embodiments of the present invention will be explained with reference to the accompanying drawings.

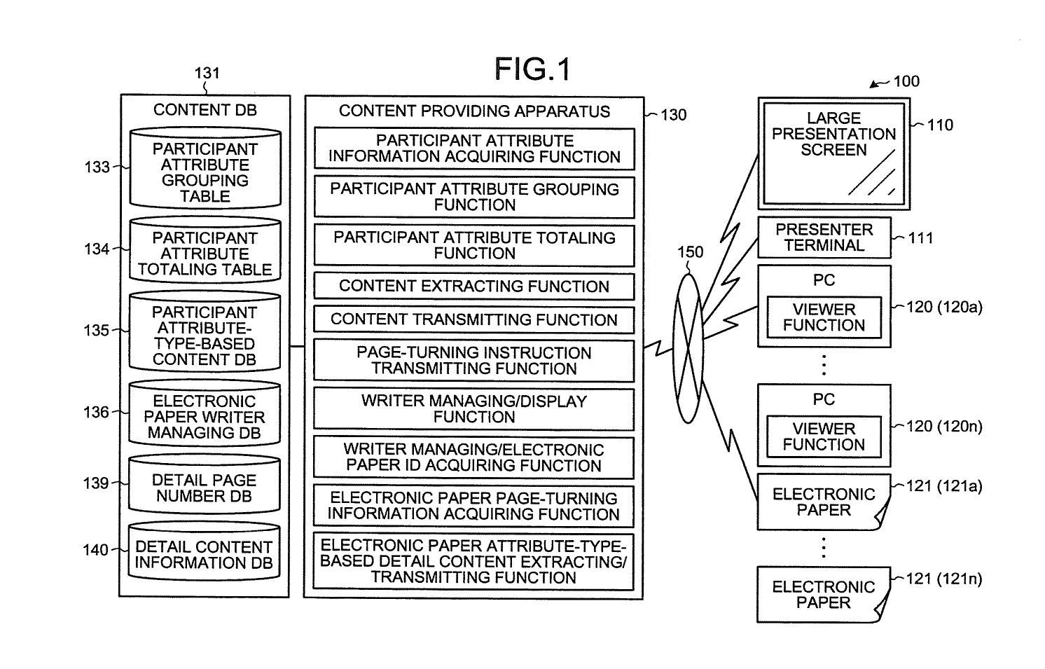

FIG. 1 is an explanatory diagram of a configuration of a content providing system that includes a content providing apparatus according to an embodiment. The content providing system, for example, is the system that, at a presentation hall where details concerning insurance products are presented to participants, provides each of the participants with information concerning an appropriate insurance product, from among information to be presented (hereinafter “content”) concerning various insurance products. Presentation information (content) that is displayed on a large presentation screen 110 or is distributed to participants as printed matter in an ordinary presentation is transformed into electronic data and is displayed on participant terminals 120 and 121.

As depicted in FIG. 1, a content providing system 100 includes the large presentation screen 110, a presenter terminal 111, terminal devices 120 and 121, and a content providing apparatus 130 that provides content to participants via the terminal devices 120 and 121. The components making up the content providing system 100 are physically or wirelessly interconnected through a network 150.

At least one unit of the large presentation screen 110 is disposed in the presentation hall where insurance products are presented. The large presentation screen 110 may be implemented by, for example, a projector, a liquid crystal display or plasma display having a large screen, etc.

The presenter terminal 111 is an information terminal device (provider terminal) used by a presenter presenting the insurance products to specify and update content displayed on the large presentation screen 110 (e.g., a screen (information) displayed on the large presentation screen 110 (hereinafter “page”)). The presenter terminal 111 includes units, which are not depicted, such as an operating unit that the presenter uses to operate the presenter terminal 111, a display unit that displays information in response to the operation of the operating unit by the presenter, and a communication unit that communicates with the content providing apparatus 130 according to the operation of the operating unit by the presenter.

In this embodiment, the presenter terminal 111 includes the large presentation screen 110 as a display unit, i.e., the presenter terminal 111 and the large presentation screen 110 are integrated. A process of updating a page displayed on the large presentation screen 110 through operation at the presenter terminal 111 will be described later.

The presenter terminal 111, before the start of the presentation, acquires a content file used for the presentation and stores the acquired content file in a given memory area. The content file is information that includes various content (pages) classified according to the attributes of participants. The presenter terminal 111 acquires a content file that is presentation information concerning an insurance product for a typical participant among participants participating in the presentation, as the content file to be used for the presentation.

The typical participant is determined based on the attributes of participants, such as age and gender. For example, participant attributes greatest in the number among the participants at the presentation (attribute greatest in number) are determined to be attributes of the typical participant. For example, when among 100 participants, 5 are women in their twenties, 10 are men in their twenties, 40 are women in their thirties, 10 are men in their thirties, 15 are women in their forties, and 20 are men in their forties, the typical participant is determined to be a woman in her thirties because women in their thirties are greatest in number (40) among the participants. In addition to age and gender, the attributes of participants can be set based on, for example, marital status, number of children, annual income, smoking or nonsmoking, medical history, possession of a driver's license, possession of a special driver's license issued to drivers with a good driving record, etc.

The presenter terminal 111 extracts the corresponding content (page) from an acquired content file according to the operation of the operating unit, and displays the extracted content on the display unit. The large presentation screen 110 displays the content (page) for the same attribute as the content (page) displayed by the display unit of the presenter terminal 111.

The presenter terminal 111 and the large presentation screen 110 may be provided as separate units independent of each other, i.e., the presenter terminal 111 may have a display unit that is independent of the large presentation screen 110. When the presenter terminal 111 and the large presentation screen 110 are separate units independent of each other, the presenter terminal 111 causes the large presentation screen 110 to display updated (page-turned) content (page) at each update (page-turning) of the content displayed on the display unit. Since a technique of updating a page on the separate large presentation screen 110 through operation at the presenter terminal 111 is a known technique, the description of such technique will be omitted.

When the presenter terminal 111 and the large presentation screen 110 are separate units independent of each other, the presenter terminal 111 transmits to the content providing apparatus 130 at each update (page-turning) of the content (page) displayed on the display unit, page-turning instruction information indicative of the occurrence of updating (page-turning) of content (page).

Upon receiving page-turning instruction information transmitted from the presenter terminal 111, the content providing apparatus 130 transmits to the terminal devices 120 and 121, page-turning instruction information for updating content (page) displayed on the display screens of the terminal devices 120 and 121. The content providing apparatus 130 transmits the page-turning instruction information including at least one among information identifying the updated (page-turned) content (page) and the updated content (page) itself.

The content providing apparatus 130 includes a radio transmitting unit (not depicted) and using the radio transmitting unit, transmits page-turning instruction information to each of the terminal devices 120 and 121 by radio communication. Page-turning instruction information may be transmitted by cable communication through a cable connecting the content providing apparatus 130 to each of the terminal devices 120 and 121. Details of the content providing apparatus 130 will be described later.

The terminal devices 120 and 121 are distributed to each participant and respectively have a participant terminal ID for identifying the terminal device itself.

The attributes of the participant using the terminal devices 120 and 121 are correlated with the participant terminal IDs. Based on the correlation between the participant terminal ID and the attributes, the content providing apparatus 130 transmits the corresponding page-turning instruction information to each of the terminal devices 120 and 121.

Each of the terminal devices 120 and 121 is an information terminal device (participant terminal) used by a participant. Each of the terminal devices 120 and 121 has a communication unit that receives page-turning instruction information transmitted from the content providing apparatus 130 and a display unit that displays content (page) based on the received page-turning instruction information. Upon receiving the page-turning instruction information transmitted from the content providing apparatus 130, the terminal devices 120 and 121 display content (page) based on the received page-turning instruction information.

The terminal devices 120 and 121 may be implemented by, for example, a PC, electronic paper, etc. Participant terminals in the content providing system 100 may be PCs or electronic papers, or both. Hereinafter, a PC serving as a participant terminal will be denoted by reference numeral 120 and an electronic paper serving as a participant terminal will be denoted by reference numeral 121 in the following description. The content providing system 100 includes plural PCs 120 (120a to 120n) and plural electronic papers 121 (121a to 121n).

In addition to the communication unit and the display unit described above, the PC 120 also includes a given memory area that stores therein a content file used for a presentation. Before the start of the presentation, the PC 120 acquires the content file used for the presentation and stores the acquired content file in the given memory area. The content file to be acquired and stored by the PC 120 is determined based on the attributes of the participant who uses the PC 120. For each participant using a PC 120, the attributes of the participant are correlated in advance (before the acquisition of the content file) with the PC 120 to be used by the participant. This correlating will be described later.

The PC 120 has a viewer function of displaying content (page). With this viewer function, the PC 120 receives from the content providing apparatus 130 as a result of, for example, a page-turning operation at the presenter terminal 111, page-turning instruction information that includes information identifying content after page-turning (new page), and based on the received page-turning instruction information, displays on the display unit, content (page) extracted from a content file stored in the given memory area. The viewer function thus allows the PC 120 to update content on display to the content after page-turning (new page) when the content (page) displayed on the display unit of the presenter terminal 111 is updated (page-turned).

The PC 120 may be implemented by, for example, various known terminal devices, such as a desktop or notebook PC and PDA. Configuration and function of the PC 120 are known technologies; hence, description thereof will be omitted. When receiving page-turning instruction information including updated content (page), the PC 120 displays the content (page) indicated by the page-turning instruction information on the display unit.

When the electronic paper 121 receives page-turning instruction information including updated content (page), the electronic paper 121 displays the content (page) indicated by the page-turning instruction information on the display unit. The electronic paper 121 does not store the entire content file therein, rather at each reception of page-turning instruction information, displays on the display unit, content included in the received page-turning instruction information.

The electronic paper 121 has a radio receiving unit (not depicted) that receives page-turning instruction information transmitted from the radio transmitting unit of the content providing apparatus 130, and this radio receiving unit serves as the above communication unit, thereby enabling the electronic paper 121 to display content (page) on its display unit even if the electronic paper 121 is detached from an electronic paper writer that records the content to the electronic paper 121.

The electronic paper 121 is implemented by, for example, electronic paper adopting any scheme among microencapsulation, electronic particles, liquid crystal, and electrowetting. Configuration and function of the electronic paper 121 are known technologies; hence, description thereof will be omitted.

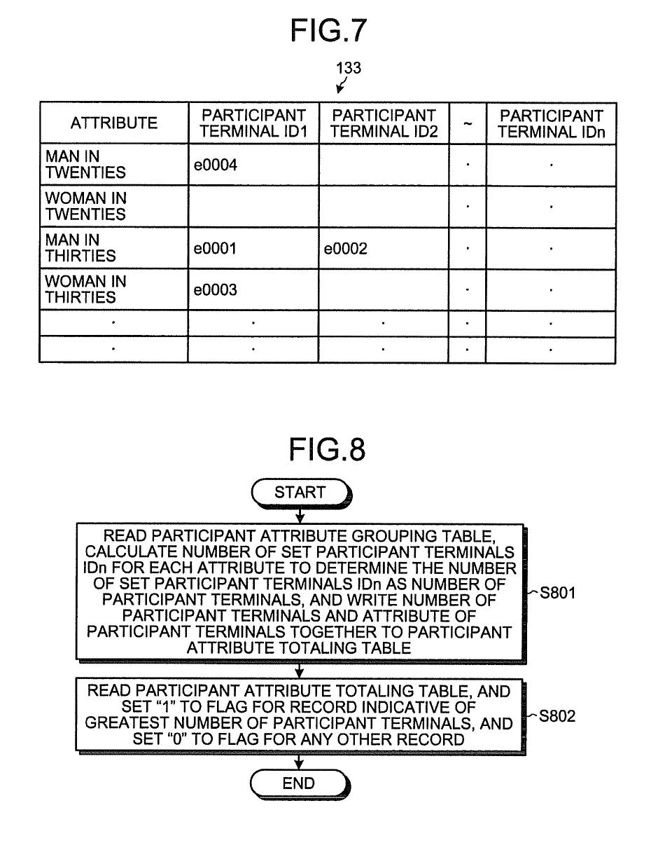

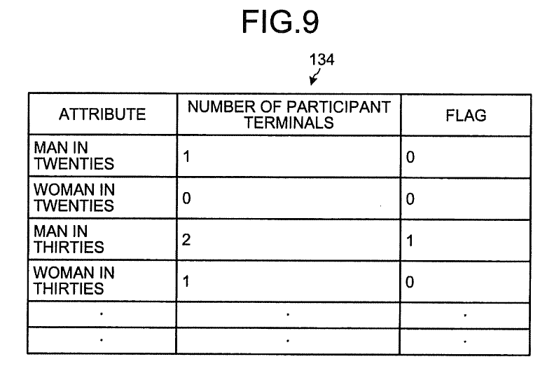

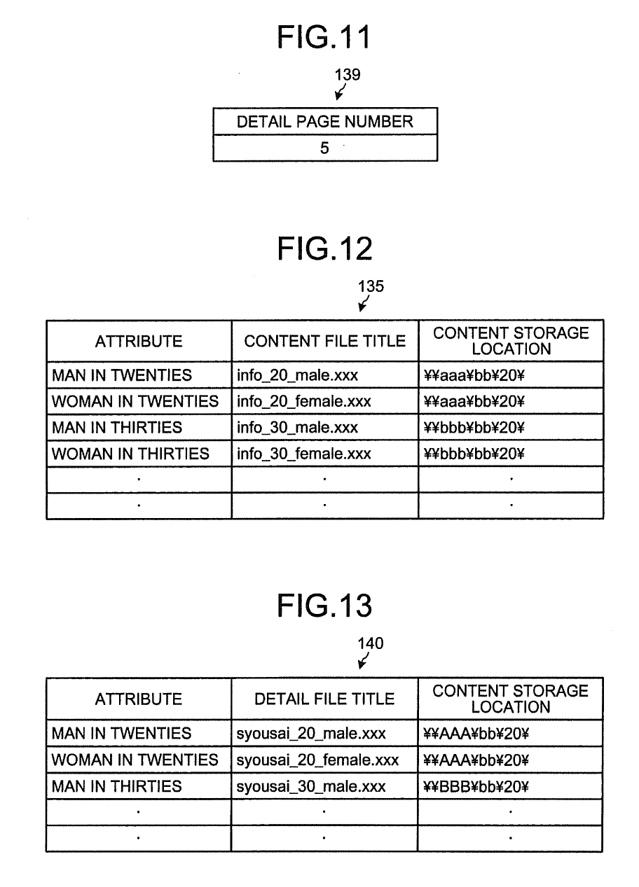

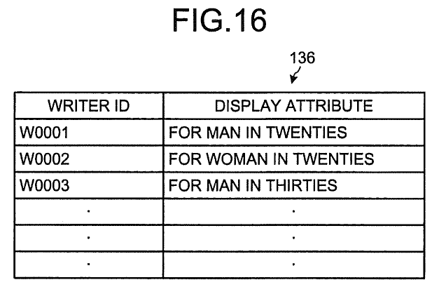

A content DB 131 will be described. The content providing apparatus 130 of this embodiment is connected to the content DB 131 that stores therein various types of data, and based on the data stored in the content DB 131, various functions depicted in FIG. 1 are implemented. The content DB 131 includes various DBs and tables having various set data used when the content providing system 100 is used, such as a participant attribute grouping table 133 (see FIG. 7), a participant attribute totaling table 134 (see FIG. 9), a participant attribute-type-based content DB 135 (see FIG. 12), an electronic paper writer managing DB 136 (see FIG. 16), a detail page number DB 139 (see FIG. 11), and a detail content information DB 140 (see FIG. 13). These DBs and tables will be described later.

The content DB 131 is also provided with a content file DB that stores therein content to be displayed on the large presentation screen 110 and the electronic papers 121. The content file DB stores therein standard presentation information for an insurance product (hereinafter “ordinary content”) and presentation information giving more detailed information concerning an insurance product than ordinary content (hereinafter “detail content”).

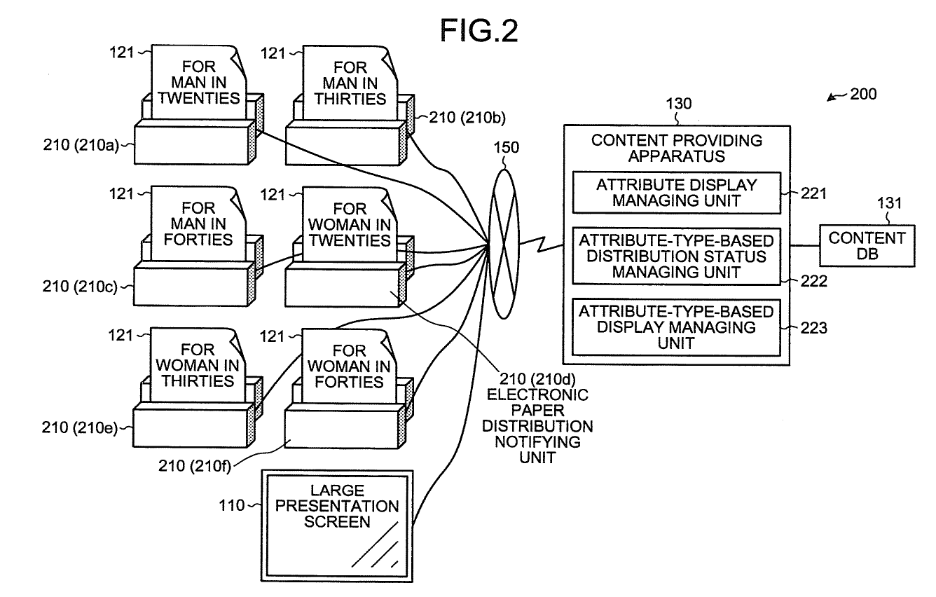

FIG. 2 is an explanatory diagram of a configuration of an electronic paper managing system. The electronic paper managing system 200 depicted in FIG. 2 is used when participant terminals in the content providing system 100 are electronic papers 121. The electronic paper managing system 200 is a system for displaying content on the above large presentation screen 110 and the electronic papers 121.

As depicted in FIG. 2, the electronic paper managing system 200 includes the large presentation screen 110 depicted in FIG. 1, the electronic papers 121, multiple electronic paper writers 210 (hereinafter, referred to as “electronic paper writers 210a to 210f” when necessary), and the content providing apparatus 130. These components are interconnected via the network 150.

Each electronic paper writer 210 has a mounting unit on which each electronic paper 121 is set and a recording unit that records content to the electronic paper 121 set on the mounting unit. The electronic paper 121 set on the mounting unit is removable from the mounting unit for portability.

The recording unit carries out recording to the electronic paper 121 according to a method defined according to the type of the electronic paper 121. The recording unit of each electronic paper writer 210 carries out recording to the electronic paper 121 when the electronic paper 121 is mounted. The electronic paper writers 210 and the content providing apparatus 130 may be connected physically or wirelessly.

As depicted in FIG. 2, the content providing apparatus 130 includes an attribute display managing unit 221, an attribute-type-based distribution status managing unit 222, and an attribute-type-based display managing unit 223. FIG. 2, among various functional units included in the content providing apparatus 130, depicts functional units related to an electronic paper managing function.

The attribute display managing unit 221, the attribute-type-based distribution status managing unit 222, and the attribute-type-based display managing unit 223 implement various functions for displaying content on the electronic paper by using information stored in the electronic paper writer managing DB 136, the detail page number DB 139, etc., included in the content DB 131.

When the content providing apparatus 130 is connected to electronic paper writers 210 via cables, the attribute display managing unit 221 identifies attribute information correlated with each electronic paper writer 210, i.e., attribute information correlated with each electronic paper 121. The attribute-type-based distribution status managing unit 222 determines which attribute (display attribute) is correlated with which electronic paper, based on, for example, the participant attribute grouping table 133 (see FIG. 7 to be described later). When the content providing apparatus 130 is connected to electronic papers 121 via radio waves, the attribute-type-based display managing unit 223 determines which content corresponding to which attribute each electronic paper writer 210 is to be displayed (recorded).

In the above configuration, when the electronic paper 121 is used as the participant terminal, content correlated with the corresponding attribute is recorded to the electronic paper 121 before the start of a presentation. Each participant takes an electronic paper 121 having recorded thereto content corresponding to the attribute of the participant, from among electronic papers 121 displaying (recording) content that are prepared at the entrance of the presentation hall, and then takes a seat. For example, if a participant is a woman in her thirties, the participant finds a clue of such characters “for woman in thirties” displayed on the electronic paper 121 when entering the hall and thus pulls out the corresponding electronic paper 121.

Staff of the organization holding the presentation, such as an employee of an insurance company, sets a new blank electronic paper 121 on the electronic paper writer 210 from which the electronic paper 121 has been pulled out. When the new blank electronic paper 121 is set, the electronic paper writer 210 newly displays (records) on the new blank electronic paper 121, content correlated with the attribute corresponding to the electronic paper writer 210.

In the electronic paper managing system 200, each time an electronic paper 121 is pulled out, content correlated with the same attribute as the attribute of the pulled out electronic paper 121 is displayed (recorded) on a blank electronic paper 121. As a result, an attribute assigned to the electronic paper writer 210 from which the greatest number of electronic papers is pulled out is determined to be the attribute greatest in number among participants (typical participant).

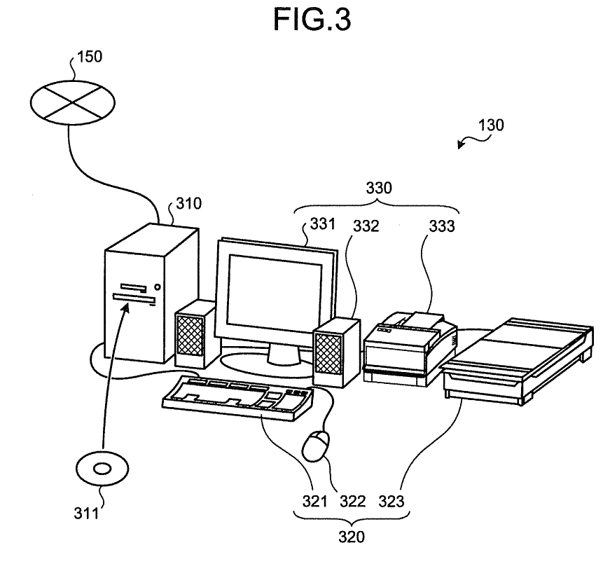

FIG. 3 is an external view of a content providing apparatus 130 according to the embodiment. As depicted in FIG. 3, a content providing apparatus 130 includes a computer 310, an input device 320, and an output device 330, and may be connected with the network 150, e.g., a local area network (LAN), a wide area network (WAN), or the Internet through a non-depicted router or a modem.

The computer 310 has a central processing unit (CPU), a memory, and an interface. The CPU governs overall control of the content providing apparatus 130. The memory is formed of, for example, read-only memory (ROM), a random access memory (RAM), a hard disk (HD), an optical disk 311, or a flash memory. The memory is used as a work area of the CPU.

Various programs are stored in the memory and loaded in response to a command from the CPU. The reading and the writing of data with respect to the HD and the optical disk 311 are controlled by a disk drive. The optical disk 311 and the flash memory are removable. The interface controls input from the input device 320, output to the output device 330, and transmission/reception with respect to the network 150.

As the input device 320, a keyboard 321, a mouse 322, and a scanner 323 are adopted. The keyboard 321 includes keys to input, for example, characters, numeric figures, and various kinds of instructions, and data is input through the keyboard 321. The keyboard 321 may be a touch panel. The mouse 322 is used to move a cursor, select a range, move a window, or change window size. The scanner 323 optically reads an image as image data, which is stored in the memory of the computer 310. The scanner 323 may have an optical character recognition (OCR) function.

As the output device 330, a display 331, a speaker 332, a printer 333, etc. are adopted. The display 331 displays a cursor, an icon, or a tool box as well as data, such as text, an image, and function information. The speaker 332 outputs sound, e.g., a sound effect or a text-to-voice converted sound. The printer 333 prints image data or text data.

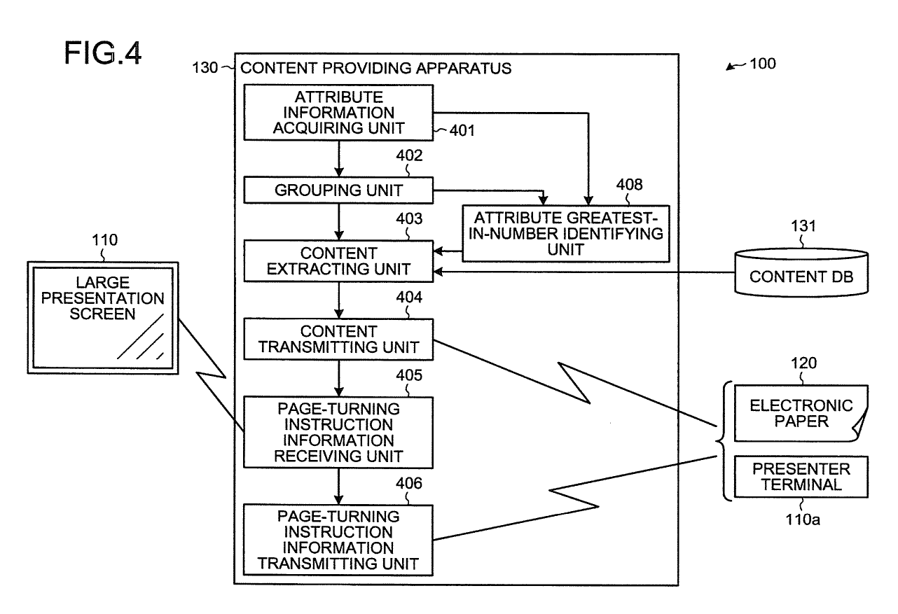

FIG. 4 is an explanatory diagram of a functional configuration of the content providing apparatus 130 according to the embodiment. As depicted in FIG. 4, the content providing apparatus 130 includes an attribute information acquiring unit 401, a grouping unit 402, a content extracting unit 403, a content transmitting unit 404, a page-turning instruction information receiving unit 405, a page-turning instruction information transmitting unit 406, and an attribute greatest-in-number identifying unit 408.

The attribute information acquiring unit 401 acquires attribute information for a participant input by the participant or an insurance company employee. The grouping unit 402 generates the participant attribute grouping table 133 based on attribute information acquired by the attribute information acquiring unit 401. As a result, participants are grouped by attribute into attribute-based groups.

The content extracting unit 403 may extract content correlated with the attribute of a participant from content stored in the content DB 131 (content file and content for each page) according to the result of grouping by the grouping unit 402.

The content transmitting unit 404 transmits the content extracted by the content extracting unit 403 to the corresponding terminal device (PC 120, electronic paper 121), and also transmits the content extracted by the content extracting unit 403 to the large presentation screen 110. The terminal device (PC 120, electronic paper 121) and the large presentation screen 110 each receive the content transmitted from the content transmitting unit 404 to display the received content on the display unit of each terminal device (PC 120, electronic paper 121) and the large presentation screen 110.

The attribute greatest-in-number identifying unit 408 identifies the attribute of a group having the greatest number of terminal devices (PC 120, electronic paper 121) (attribute greatest in number) among the groups resulting from grouping by the grouping unit 402.

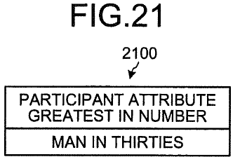

While the grouping unit 402 is provided in FIG. 4, the attribute greatest in number may be identified without the grouping unit 402, based on attribute information acquired by the attribute information acquiring unit 401 and on participant terminal IDs of the terminal devices (PC 120, electronic paper 121). In this case, the attribute greatest-in-number identifying unit 408 uses a participant terminal ID/attribute associated table (see FIG. 19), instead of using the participant attribute grouping table 133, to generate a participant attribute greatest in number table (see, FIG. 21) to identify the attribute greatest in number.

The content transmitting unit 404 transmits to the large presentation screen 110, content correlated with the attribute greatest in number identified by the attribute greatest-in-number identifying unit 408. The page-turning instruction information receiving unit 405 receives page-turning instruction information transmitted from the presenter terminal 111. Based on the page-turning instruction information received by the page-turning instruction information receiving unit 405, the page-turning instruction information transmitting unit 406 transmits page-turning instruction information to the large presentation screen 110 and the terminal device (PC 120, electronic paper 121).

Functions of the attribute information acquiring unit 401, the grouping unit 402, the content extracting unit 403, the content transmitting unit 404, the page-turning instruction information receiving unit 405, the page-turning instruction information transmitting unit 406, and the attribute greatest-in-number identifying unit 408 depicted in FIG. 4 are implemented, for example, by using the CPU, memory, and interface included in the computer 310 depicted in FIG. 3 to cause the CPU to execute a program stored in the memory and output the result of execution of the program to an external destination via the interface.

A series of processing by the content providing system 100 will be described. Processing by the content providing system 100 partially varies depending on whether the participant terminal is the PC 120 or the electronic paper 121.

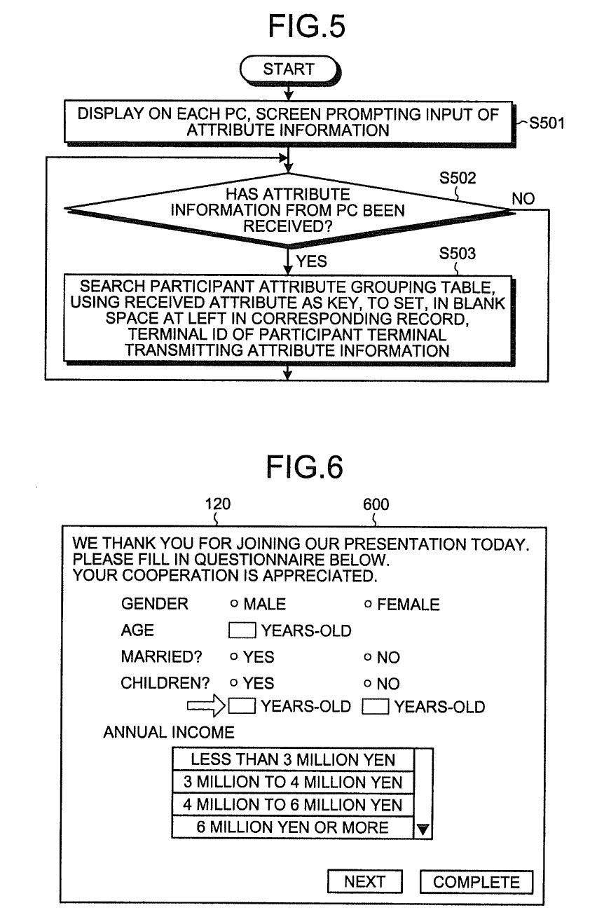

A series of processing by the content providing system 100 when the participant terminal is the PC 120 will be described first. Processing by the content providing system 100 is implemented in principle through the following procedures (see flowcharts of FIGS. 5, 8, and 10). The processing depicted in FIGS. 5, 8, and 10 is executed appropriately by the devices making up the content providing apparatus 100.

FIG. 5 is a flowchart (1) of an example of a participant attribute information acquiring/grouping process. As depicted in the flowchart of FIG. 5, each PC 120 is caused to display a screen prompting attribute input (see FIG. 6 to be described later) (step S501). At step S501, the content providing apparatus 130 transmits to each PC 120, a command commanding execution of a process of displaying the screen prompting attribute input. The transmitted command causes each PC 120 to start the above viewer function of the PC 120 and to display the screen prompting attribute input.

FIG. 6 is an explanatory diagram of an example of a screen displayed by the PC 120. The screen 600 depicted in FIG. 6 is a screen prompting attribute input and is displayed on the display unit of each PC 120 before the start of the presentation. As depicted in FIG. 6, the screen 600 displays information requesting input of information used for determining the attributes of each participant. Information used for determining the attributes of the participant includes, for example, information on the participants' gender, age, marital status, number of children, estimated annual income, etc.

Before the start of the presentation, the participants input attributes according to content displayed on the screen 600 and operate an “input completion” key to indicate the end of input. When the “input completion” key is operated, the PC 120 transmits to the content providing apparatus 130, an input completion signal indicative of the end of input.

Subsequently, at step S502, whether the content providing apparatus 130 has received attribute information transmitted from the PC 120 is determined (step S502). At step S502, for example, whether the attribute information transmitted from the PC 120 has been received is determined by determining whether the content providing apparatus 130 has received the input completion signal transmitted from the PC 120.

If the content providing apparatus 130 has not received the attribute information transmitted from the PC 120 (step S502: NO), reception of the attribute information is waited for. If the content providing apparatus 130 has received the attribute information (step S502: YES), the participant attribute grouping table 133 (see FIG. 7 to be described later) is searched, using the received attribute information (attribute) as a key, to set the terminal ID of the PC 120 having transmitted the received attribute information in the corresponding blank space (step S503). The procedure then proceeds to step S502, where the processing of step S503 is executed repeatedly at each reception of attribute information transmitted from the PC 120.

FIG. 7 is an explanatory diagram of the contents of the participant attribute grouping table 133. The participant attribute grouping table 133 includes set information concerning various items including an “attribute” item indicating the attributes of participants in the presentation and a “participant terminal IDn” item representing 1 to n participant terminal IDs.

In the attribute item, attribute information correlated with a participant terminal ID is set. For example, information of “man in twenties” given by combining such attribute information as “twenties” and “man” input on the screen 600 is set in the attribute item. In the participant terminal IDn item, each participant terminal ID (e0001, e0002, etc.) assigned to each PC 120 is set correlated to the corresponding attribute.

Participant terminal IDs are set sequentially in blank spaces depicted in FIG. 7 by starting from a space at the farthest left. For example, when a PC 120 (with a participant terminal ID e0001) used by a man in his thirties is set on the participant attribute grouping table 133 having blank spaces only, “e0001” is set in the blank space at the left (participant terminal ID1 space) among blank spaces corresponding to an attribute item of “man in his thirties”.

When another PC 120 (with a participant terminal ID e0002) used by a man in his thirties is set additionally, “e0002” is set in the blank space (participant terminal ID2 space) on the right of the space in which “e0001” is set. When another PC 120 (with a participant terminal ID e0003) used by a woman in her thirties is set additionally, “e0003” is set in a blank space at the left (participant terminal ID1 space) among blank spaces corresponding to an attribute item of “woman in her thirties”.

FIG. 8 is a flowchart of an example of a grouping participant attribute-greatest-in-number identifying process. As depicted in the flowchart of FIG. 8, the content providing apparatus 130 reads the participant attribute grouping table 133 to calculate the number of set participant terminal IDs for each attribute, and writes to the participant attribute totaling table 134, the calculated number of set participant terminal IDs as the number of participant terminal IDs for each attribute (step S801).

FIG. 9 is an explanatory diagram of the contents of the participant attribute totaling table 134. As depicted in FIG. 9, the participant attribute totaling table 134 includes set information of various items including an “attribute” item, a “number of participant terminals” item indicating the number of PCs 120 corresponding to each attribute, and a “flag” item. The participant attribute totaling table 134 is generated according to information set in the participant attribute grouping table 133.

In the participant attribute totaling table 134, the number of participant terminals item represents the number of participant terminal IDs for each attribute item set in the participant attribute grouping table 133. In the participant attribute totaling table 134, the flag item provides information for identifying the attribute item with the greatest number of participant terminals among attribute items. A flag “1” is set to the attribute item representing the attribute greatest in number, while a flag “0” is set to attribute items other than such attribute item. Each of the items in the participant attribute totaling table 134 is set according to information in the participant attribute grouping table 133.

At step S802, the content providing apparatus 130 reads in the numbers of participant terminals written to the participant attribute totaling table 134 at step S801, and sets “1” to a flag item in a record indicative of the greatest number of participant terminals, and sets “0” to flag items in records other than such record. Hence, the grouping participant attribute greatest in number identifying process comes to an end.

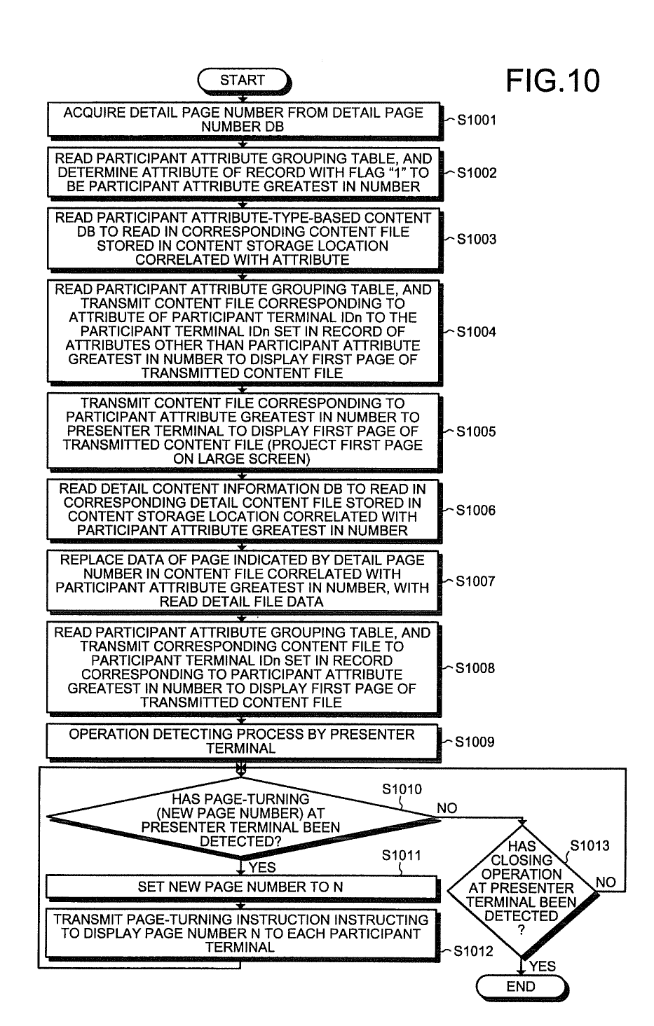

FIG. 10 is a flowchart (1) of an example of content-tied display processing. As depicted in the flowchart of FIG. 10, the content providing apparatus 130 acquires a detail page number from the detail page number DB 139 (step S1001).

FIG. 11 is an explanatory diagram of the contents of the detail page number DB 139. As depicted in FIG. 11, the page number of the page (detail page) having content that includes detailed information (detailed content) among the content displayed on the large presentation screen 110 (display unit of the presenter terminal 111) and PCs 120 is set in the detail page number DB 139. The detail page number DB 139 is provided when detail content is present for an attribute, and may not be provided for all attributes.

A page number set in the detail page number DB 139 is the page number of content (page) that includes detailed information, and may not be set for all content (pages) making up a content file. The PC 120 displays detail content with preference over ordinary content for an attribute for which a detail page number set in the detail page number DB 139 is present.

At step S1002, the participant attribute totaling table 134 is read, and the attribute of a record with the flag “1” is determined to be the participant attribute greatest in number (step S1002). The participant attribute-type-based content DB 135 (see FIG. 12) is then read to read in the corresponding content files stored in content storage locations correlated with (associated with) each attribute (step S1003).

FIG. 12 is an explanatory diagram of the contents of the participant attribute-type-based content DB 135. As depicted in FIG. 12, the participant attribute-type-based content DB 135 includes set information of various items including an “attribute” item, a “content file title” item indicating the title of a content file assigned to each attribute, and a “content storage location” item indicating the storage location of the content file indicated by the content file title. A content storage location is indicated by, for example, hierarchical expression, such as a path title “20 in a folder bb in a folder aaa (in DB)”.

At step S1004, the participant attribute grouping table 133 is read, and content files corresponding to respective attributes of PCs 120 whose participant terminal ID is set in a record for an attribute other than the participant attribute greatest in number are transmitted to the PCs 120 to display the first page of the transmitted content files on the PCs 120 (step S1004).

The content file corresponding to the participant attribute greatest in number is then transmitted to the presenter terminal 111 to display the first page of the transmitted content file on the display unit of the presenter terminal 111 (large presentation screen 110) (step S1005). Steps S1004 and S1005 may be executed in reverse order, in which case step S1004 is executed after executing step S1005. Subsequently, the detail content information DB 140 (see FIG. 13) is read to read in the corresponding detail content stored in a content storage location correlated with the participant attribute greatest in number (step S1006).

FIG. 13 is an explanatory diagram of the contents of the detail content information DB 140. As depicted in FIG. 13, the detail content information DB 140 includes set information of various items including an “attribute” item, a “detail file title” item indicating the title of a content file assigned to each attribute, and a “content storage location” item indicating the storage location of the content file indicated by a detail file title. A storage location of detail content corresponding to a detail page number set in the detail page number DB 139 may be identified based on the detailed content information DB 140.

At step S1007, in the content file correlated with the participant attribute greatest in number, content corresponding to a page indicated by the detail page number is replaced with the detail content read in at step S1006. The participant attribute grouping table 133 is then read in, and the content file corresponding to the attribute of the PC 120 is transmitted to the PC 120 having the participant terminal ID set in the record corresponding to the participant attribute greatest in number to display the first page of the transmitted content file on the PC 120 (step S1008).

Subsequently, an operation detecting process by the presenter terminal 111 is carried out (step S1009). The operation detecting process is the process carried out in such a way that when a page-turning operation is executed at the presenter terminal 111, a page number (new page number) resulting after page-turning is transmitted from the presenter terminal 111 to the content providing apparatus 130.

The content providing apparatus 130 determines whether page-turning (new page number) at the presenter terminal 111 has been detected, the new page number being that transmitted from the presenter terminal 111 by the operation detecting process at step S1009 (step S1010). When having detected the page-turning (new page number) (step S1010: YES), the content providing apparatus 130 sets the new page number to “N” (step S1011). Subsequently, page-turning instruction information for displaying the content corresponding to the page number “N” is transmitted to each PC 120 (step S1012), after which the process flow returns to step S1010.

When not having detected the page-turning (new page number) at the presenter terminal 111 at step S1010 (step S1010: NO), the content providing apparatus 130 determines whether closing operation at the presenter terminal 111 has been detected (step S1013). If the closing operation at the presenter terminal 111 has not been detected (step S1013: NO), the process flow returns to step S1010. If the closing operation at the presenter terminal 111 has been detected (step S1013: YES), the content-tied display processing is ended.

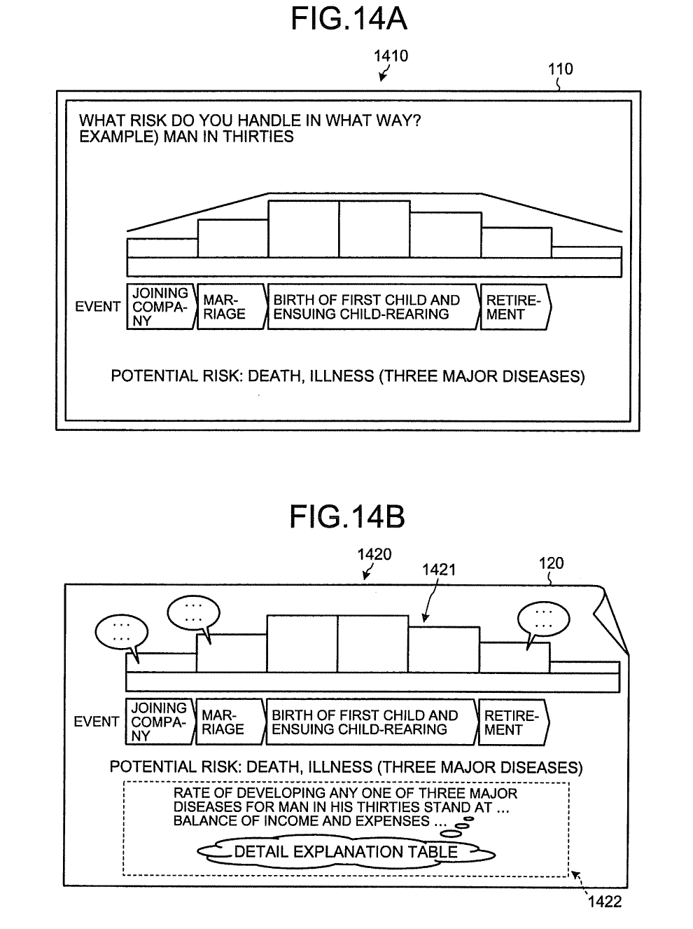

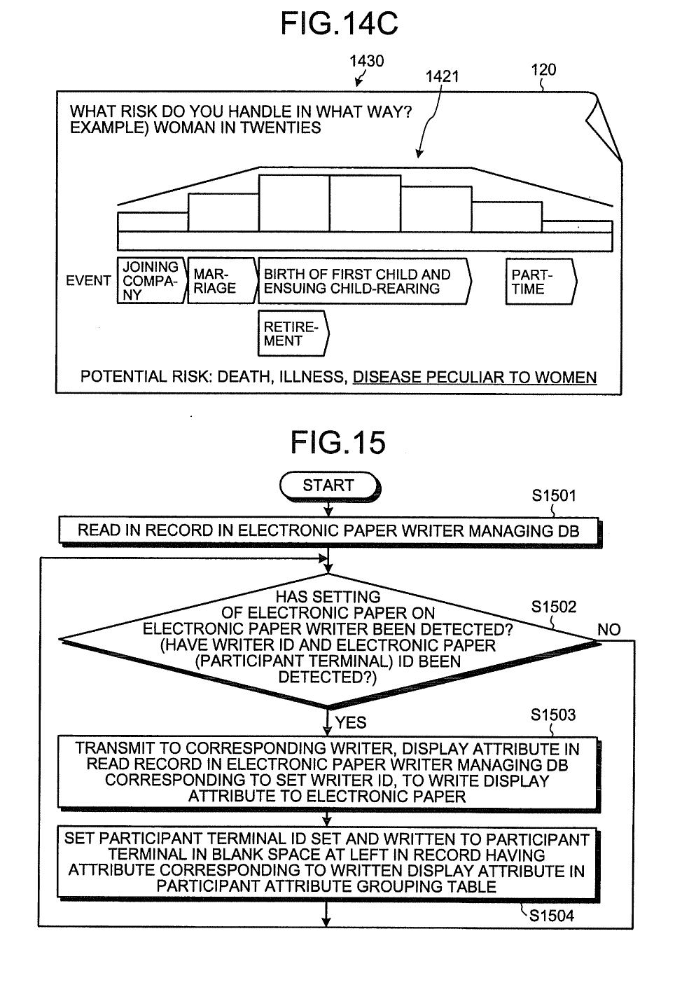

FIGS. 14A to 14C are explanatory diagrams of examples of display screens. Each of the display screens depicted in FIGS. 14A to 14C is an example of a display screen output by a series of processing by the above content providing system 100.

FIG. 14A depicts an example of a display screen appearing on the large presentation screen 110. In FIG. 14A, the display screen 1410 depicts details of an insurance product that is offered when a “man in his thirties” is a participant corresponding to the attribute greatest in number in a presentation hall. When the large presentation screen 110 and the presenter terminal 111 are separate units independent of each other, the display screen 1410 is output not only on the large presentation screen 110 but also on the display unit of the presenter terminal 111.

FIG. 14B depicts an example of a display screen appearing on the PC 120 used by a participant corresponding to the attribute greatest in number. The display screen 1420 of FIG. 14B also depicts an example of a display screen appearing on the electronic paper 121 distributed to a participant who is a “man in his thirties” belonging to a layer of the greatest number of participants. In FIG. 14B, the display screen 1420 depicts characteristic supplementary content 1422 aimed at men in their thirties, in addition to the content 1421 on the display screen 1410.

In this manner, a participant who is a man in his thirties, which is the attribute greatest in number, is provided with content more detailed than content displayed on the large presentation screen 110. Hence, participants are guided along the progress of the presentation with an explanation of a general case displayed on the large presentation screen 110 while information specially aimed at men in their thirties is introduced in detail to convey to male participants in their thirties the necessity of insurance.

Introducing information specially aimed at men in their thirties facilitates an example presuming insurance for a man in his thirties, thereby enabling the necessity for insurance to be conveyed in an understandable manner and preventing participants from becoming bored by a superficial explanation that leaves them unaware of the necessity of insurance deteriorating the participants' desire to participate in the presentation.

The detail content may be content representing an entire page having detailed information or content made up of information specially aimed at men in their thirties. The content made up of information specially aimed at men in their thirties is used in combination with the content displayed on the large presentation screen 110. In this case, the PC 120 used by a man in his thirties displays a screen made by superposing information specially aimed at men in their thirties on the content displayed on the large presentation screen 110. Specially aimed information is, for example, information that is displayed in FIG. 14B but is not displayed in FIG. 14A.

FIG. 14C is an explanatory diagram of an example of a display screen displayed by the PC 120 used by a participant corresponding to an attribute other than the attribute greatest in number or of a display screen displayed by the electronic paper 121 distributed to a participant corresponding to an attribute other than the attribute greatest in number. The display screen 1430 of FIG. 14C is displayed on a participant terminal correlated with an attribute “woman in her twenties”. As depicted in FIG. 14C, the display screen 1430 depicts events assumed to happen to women in their twenties, in addition to the content 1421 on the display screen 1410. The content providing system 100 is thus capable of guiding participants who are women in their twenties following the progress of the presentation with an explanation of a general case displayed on the large presentation screen 110 while conveying, in a more detailed manner, the necessity for women in their twenties to buy insurance.

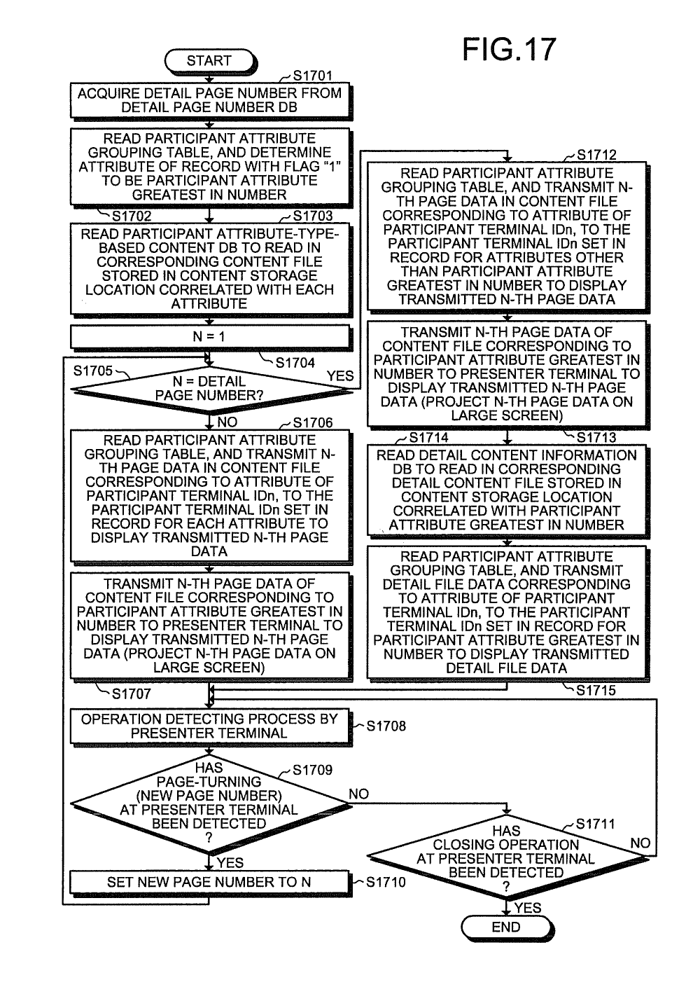

A series of processing executed by the content providing system 100 when the participant terminals are the electronic papers 121 will be described. Processing by the content providing system 100 is implemented in principle through the following procedures (see flowcharts of FIGS. 15 and 17). Processing at each of the steps depicted in FIGS. 15 and 17 is executed appropriately by the components making up the content providing apparatus 100.

FIG. 15 is a flowchart (2) of an example of the participant attribute information acquiring/grouping process. As depicted in the flowchart of FIG. 15, records in the electronic paper writer managing DB 136 are read in (step S1501).

FIG. 16 is an explanatory diagram of the contents of the electronic paper writer managing DB 136. As depicted in FIG. 16, the electronic paper writer managing DB 136 includes set information on various items including a “writer ID” item indicating the IDs of the electronic paper writers 210 and a “display attribute” item indicating the display attribute of each electronic paper writer 210. A writer ID is assigned to each of the electronic paper writers 210, serving as information for identifying each electronic paper writer 210.

Each of the items in the electronic paper writer managing DB 136 can be set when the insurance company determines the number of electronic paper writers 210 to be used and which content corresponding to which attribute is to be recorded by which electronic paper writer 210 in assignment of the electronic paper writers 210. Item setting is carried out by, for example, the insurance company determining assignment of the electronic paper writers 210.

At step S1502, whether setting of the electronic paper 121 on the electronic paper writer 210 has been detected is determined. When the electronic paper 121 is set, the electronic paper writer 210 executes a process of transmitting the writer ID of the electronic paper writer 210 and a participant terminal ID of the electronic paper 121 to the content providing apparatus 130. At step S1502, whether information indicative of the setting of the electronic paper 121 on the electronic paper writer 210 transmitted from the electronic paper writer 210 has been received is determined to determine whether the electronic paper 121 has been detected to be set on the electronic paper writer 210.

At step S1502, detection of the electronic paper 121 being set on the electronic paper writer 210 is waited for. When setting of the electronic paper 121 is detected (step S1502: YES), the display attribute corresponding to the set writer ID is written to the electronic paper 121 (step S1503). At step S1503, specifically, for example, an attribute “man in his twenties”, etc., is written to the electronic paper 121.

At step S1503, based on the record read in at step S1501, the display attribute of the writer ID of the electronic paper writer 210 having the electronic paper 121 set thereon is transmitted to the corresponding electronic paper writer 210. The transmitted display attribute is then written by the electronic paper writer 210 to the electronic paper 121 set on the electronic paper writer 210.

Subsequently, in the participant attribute grouping table 133, the participant terminal ID of the set electronic paper 121 is set sequentially in the blank space at the left in the record having the attribute corresponding to the transmitted attribute, as depicted in FIG. 7 (step S1504). Subsequently, the procedure returns to step S1502, and the processing at steps S1503 and S1504 is repeated according to a determination result at step S1502.

In the processing executed by the content providing system 100 when the participant terminals are the electronic papers 121, the grouping participant attribute greatest-in-number identifying process is executed after the participant attribute information acquiring/grouping process depicted in FIG. 15. The grouping participant attribute greatest-in-number identifying process executed after the participant attribute information acquiring/grouping process is identical to the grouping participant attribute greatest-in-number identifying process depicted FIG. 8, and is, therefore, omitted in further description.

Content-tied display processing will be described. FIG. 17 is a flowchart (2) of an example of the content-tied display processing. As depicted in the flowchart depicted in FIG. 17, a detail page number is acquired from the detail page number DB 139 (step S1701), and the participant attribute totaling table 134 is read and the attribute for a record with a flag “1” is determined to be the participant attribute greatest in number (step S1702).

The participant attribute-type-based content DB 135 is then read to read in the corresponding content files stored in the content storage locations correlated with each attribute (step S1703). Subsequently, “N” representing the page number of the content displayed by the large presentation screen 110 and the electronic paper 121 is set to “N□1” (step S1704). This sets the content displayed by the large presentation screen 110 and the electronic paper 121 to the content of the first page in the content file read in at step S1703.

Subsequently, whether “N” is the detail page number acquired at step S1701 is determined (step S1705). When “N” is not the detail page number (step S1705: NO), N-th page data in the content file is displayed on the electronic paper 121 (step S1706).

At step S1706, the participant attribute grouping table 133 is read in, and the content equivalent to the N-th page (N page data) of the content file corresponding to the attribute of the electronic paper 121 is transmitted to the electronic paper 121 whose participant terminal ID is set in the record for the attribute, to display the transmitted content (N page data) on the electronic paper 121.

Subsequently, N-th page data in the content file corresponding to the participant attribute greatest in number is transmitted to the presenter terminal 111 to display the transmitted N-th page data in the content file on the display unit of the presenter terminal 111 (large presentation screen 110) (step S1707). Steps S1706 and S1707 may be executed in reverse order, in which case step S1706 is executed after executing step S1707.

The operation detecting process by the presenter terminal 111 is then carried out in an identical manner as the operation detecting process at step S1009 (step S1708). Subsequently, whether page-turning (new page number) at the presenter terminal 111 has been detected is determined, the new page number being that transmitted from the presenter terminal 111 by the operation detecting process (step S1709). When page-turning (new page number) has been detected (step S1709: YES), the detected new page number is set to “N” (step S1710), after which the process flow returns to step S1705.

If page-turning (new page number) at the presenter terminal 111 has not been detected at step S1709 (step S1709: NO), whether closing operation at the presenter terminal 111 has been detected is determined (step S1711). If the closing operation at the presenter terminal 111 has not been detected (step S1711: NO), the process flow returns to step S1708, at which the operation detecting process by the presenter terminal 111 is carried out (step S1708). When the closing operation at the presenter terminal 111 has been detected (step S1711: YES), a series of the processing is ended.

When “N” is the detail page number at step S1705 (step S1705: YES), N-th page data in the corresponding content file is displayed on the electronic paper 121 (step S1712). At step S1712, the participant attribute grouping table 133 is read in, and N-th page data of the content file corresponding to the attribute of the electronic paper 121 is transmitted to the electronic paper 121 whose participant terminal ID is set in a record for an attribute other than the participant attribute greatest in number, to display the N-th page data in the transmitted content file on the electronic paper 121.

Subsequently, N-th page data in the content file corresponding to the participant attribute greatest in number is transmitted to the presenter terminal 111 to display the transmitted N-th page data in the content file on the display unit of the presenter terminal 111 (large presentation screen 110) (step S1713). Steps S1712 and S1713 may be executed in reverse order, in which case step S1712 is executed after executing step S1713.

The detail content information DB 140 is then read to read in the corresponding detail file stored in the content storage location correlated with the participant attribute greatest in number (step S1714). Following this, the corresponding detail content is displayed on the electronic paper 121 (step S1715).

At step S1715, the participant attribute grouping table 133 is read, and the detail content corresponding to the attribute of the electronic paper 121 is transmitted to the electronic paper 121 whose participant terminal ID is set in a record for the participant attribute greatest in number. The transmitted detail content is then displayed on the electronic paper 121, after which the process flow proceeds to step S1708 at which the operation detecting process by the presenter terminal 111 is carried out (step S1708).

In the above description, the participant terminals (PCs 120 and electronic papers 121) are grouped according to attribute and the participant attribute greatest in number is identified based on the number of the participant terminals (PCs 120 and electronic papers 121) corresponding to each of the groups resulting from grouping. However, configuration is not limited to this method.

A procedure that is carried out when content corresponding to each participant terminal (PC 120 and electronic paper 121) is displayed without grouping the participant terminals (PCs 120 and electronic papers 121) for each attribute will be described. In the case of not grouping the participant terminals (PCs 120 and electronic papers 121) according to attribute, similar to the case of grouping, processing varies partially depending on whether the participant terminals are PCs or the electronic papers 121.

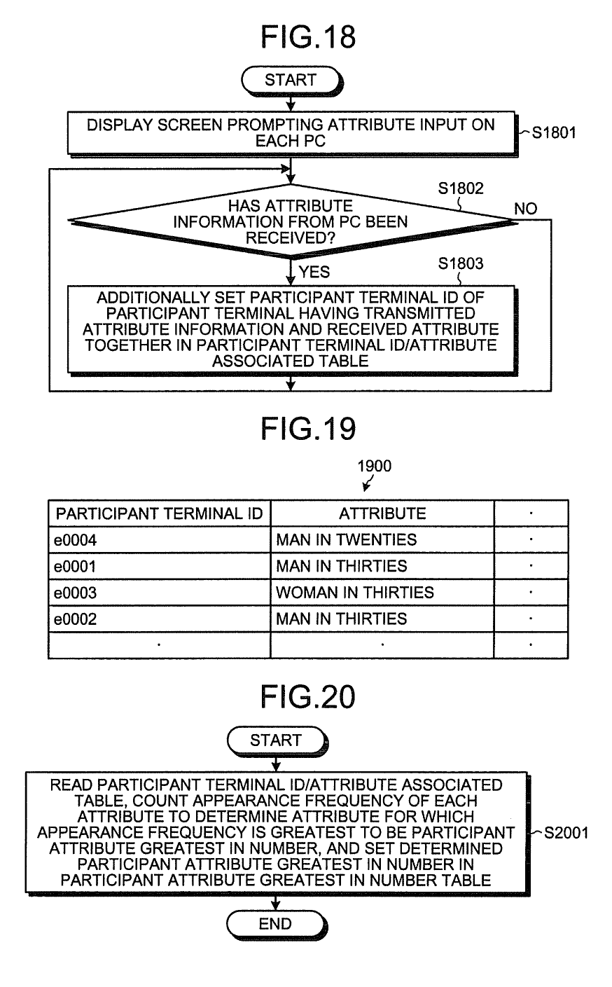

Processing that is carried out by the content providing system 100 without grouping the PCs 120 according to attribute will be described. Processing in this case is implemented in principle through the following procedures (see flowcharts of FIGS. 18, 20, and 22). The processing at the steps depicted in FIGS. 18, 20, and 22 is appropriately executed by components making up the content providing apparatus 100.

FIG. 18 is a flowchart (1) of an example of a participant attribute information acquiring/accumulating process. As depicted in the flowchart of FIG. 18, the screen 600 prompting attribute input is displayed on each PC 120 (step S1801). Subsequently, whether attribute information transmitted from the PC 120 completing attribute input has been received is determined (step S1802). If the attribute information has not been received (step S1802: NO), waiting occurs until reception of the attribute information transmitted from the PC 120.

When the attribute information has been received (step S1802: YES), the participant terminal ID of the PC 120 having transmitted the attribute information is set additionally in a participant terminal ID/attribute associated table (see FIG. 19) (step S1803). At step S1803, the attribute received at step S1802: YES is correlated with the participant terminal ID to set the participant terminal ID and the received attribute additionally in the participant terminal ID/attribute associated table.

FIG. 19 is an explanatory diagram of the contents of the participant terminal ID/attribute associated table. As depicted in FIG. 19, the participant terminal ID/attribute associated table 1900 includes set information of various items including a “participant terminal IDn” item and an “attribute” item. In the participant terminal ID/attribute associated table 1900, participant terminal IDs and attributes are correlated with each other in a one-to-one correspondence, i.e., even if plural participant terminals (PCs 120 and electronic papers 121) corresponding to the same attribute are present, the attribute is correlated with the ID of each participant terminal.

Following additional setting of the participant terminal ID, the process flow proceeds to step S1802, where it is determined whether attribute information transmitted from the PC 120 has been received (step S1802). If the attribute information has been received, the process at step S1803 is repeated.

Processing for identifying the participant attribute greatest-in-number will be described. FIG. 20 is a flowchart of an example of the processing for identifying the participant attribute greatest-in-number. As depicted in the flowchart of FIG. 20, the participant terminal ID/attribute associated table 1900 is read, and the appearance frequency of each attribute is counted to determine an attribute for which the appearance frequency is the greatest. The determined attribute is then set as the participant attribute greatest in number on the participant attribute greatest in number table (see FIG. 21) (step S2001), and a series of the processing is ended.

FIG. 21 is an explanatory diagram of the contents of the participant attribute greatest in number table. In the participant attribute greatest in number table 2100, the participant attribute greatest in number representing the attribute that is greatest in number among the attributes of participants in the presentation is set. According to the participant terminal ID/attribute associated table 1900, one PC 120 is used by a man in his twenties, two PCs 120 are used by men in their thirties, and one PC 120 is used by a woman in her thirties. As a result, “man in thirties” is set as the participant attribute greatest in number on the participant attribute greatest in number table 2100.

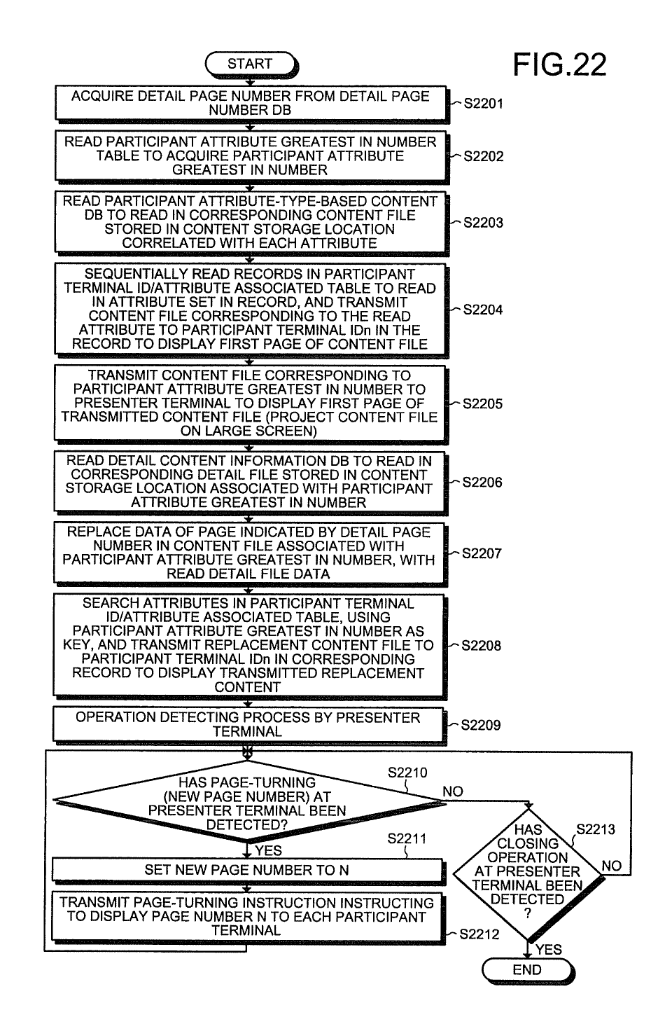

The content-tied display processing will be described. FIG. 22 is a flowchart (3) of an example of the content-tied display processing. As depicted in the flowchart of FIG. 22, a detail page number is acquired by the content providing apparatus 130 from the detail page number DB 139 (step S2201). The participant attribute greatest in number table 2100 is then read to acquire the participant attribute greatest in number (step S2202).

Subsequently, the participant attribute-type-based content DB 135 is read to read in the corresponding content files stored in content storage locations correlated with each attribute (step S2203). The first page of the corresponding content files is then displayed on the PCs 120 (step S2204).

At step S2204, records of the participant terminal ID/attribute associated table 1900 are read sequentially to read in attributes set in each of the read records, and the content file corresponding to the read attribute is transmitted to the PC 120 whose participant terminal ID is included in the read record. The first page of the transmitted content file is then displayed on the PC 120.

Subsequently, the first page of the content file corresponding to the participant attribute greatest in number is displayed on the display unit of the presenter terminal 111 (large presentation screen 110) (step S2205). At step S2205, the content file corresponding to the participant attribute greatest in number is transmitted to the presenter terminal 111 to display the first page of the transmitted content file on the display unit of the presenter terminal 111 (large presentation screen 110). Steps S2204 and S2205 may be executed in reverse order, in which case step S2204 is executed after executing step S2205.

The detail content information DB 140 is then read to read in the corresponding detail content stored in a content storage location correlated with the participant attribute greatest in number (step S2206). Content corresponding to a page indicated by the detail page number is then replaced with the read detail content in the content file correlated with the participant attribute greatest in number (step S2207).

Subsequently, the first page of the content file subjected to content replacement is displayed on the PC 120 (S2208). At step S2208, attributes in the participant terminal ID/attribute associated table 1900 are searched, using the participant attribute greatest in number as a key, and the content file subjected to content replacement is transmitted to the PC 120 whose participant terminal ID is included in the corresponding record to display the first page of the transmitted content file on the PC 120.

The operation detecting process by the presenter terminal 111 is then carried out (step S2209), and whether page-turning (new page number) at the presenter terminal 111 has been detected is determined (step S2210). If page-turning (new page number) has been detected (step S2210: YES), the detected new page number is set to “N” (step S2211). Subsequently, page-turning instruction information for displaying the content corresponding to the page number “N” is transmitted to each PC 120 (step S2212), after which the process flow returns to step S2210.

If page-turning (new page number) at the presenter terminal 111 has not been detected at step S2210 (step S2210: NO), whether closing operation at the presenter terminal 111 has been detected is determined (step S2213). If the closing operation at the presenter terminal 111 has not been detected (step S2213: NO), the process flow returns to step S2210. If the closing operation at the presenter terminal 111 has been detected (step S2213: YES), a series of processing comes to an end.

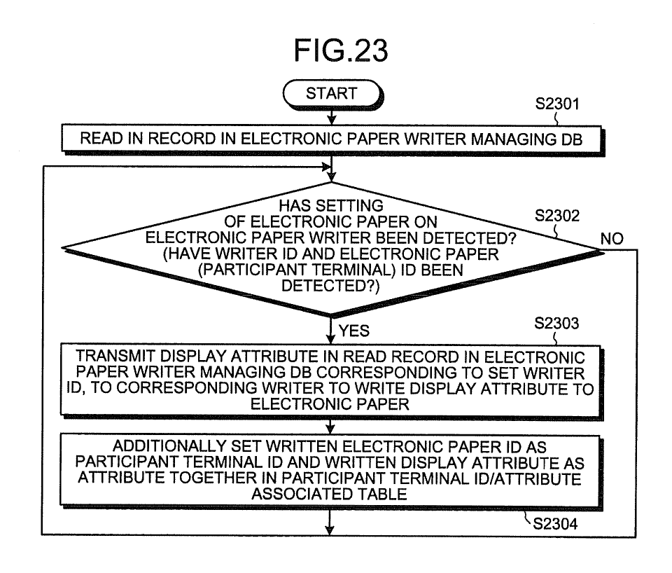

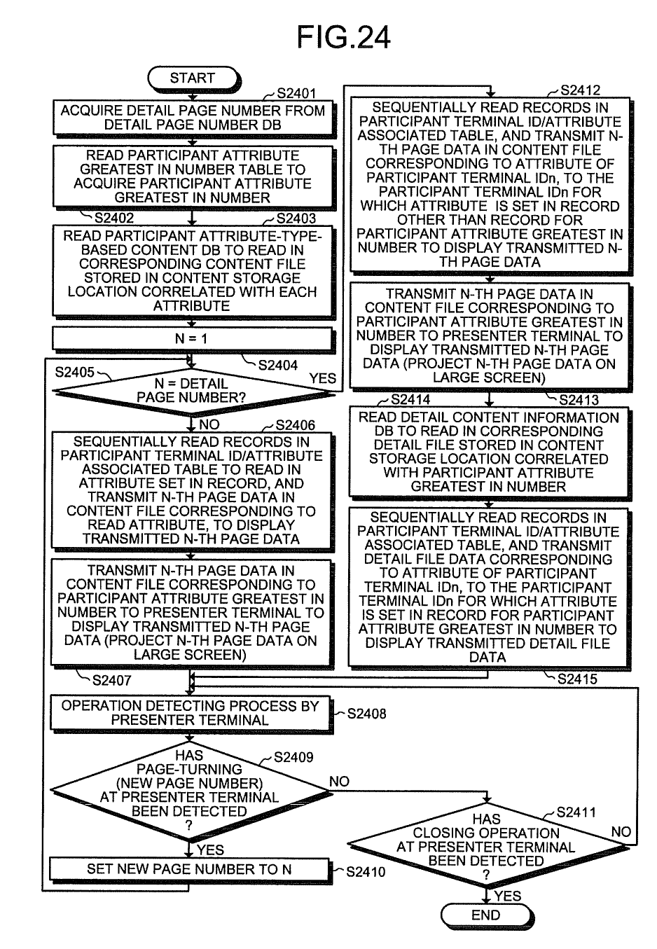

Processing that is carried out by the content providing system 100 without grouping the electronic papers 121 as the participant terminals for each attribute will be described. The processing in this case is implemented in principle through the following procedures (see flowcharts of FIGS. 23 and 24). The processing at each of the steps depicted in FIGS. 23 and 24 is executed appropriately by each component making up the content providing apparatus 100.

FIG. 23 is a flowchart (2) of an example of the participant attribute information acquiring/accumulating process. As depicted in the flowchart of FIG. 23, records in the electronic paper writer managing DB 136 are read in (step S2301), and whether setting of the electronic paper 121 on the electronic paper writer 210 has been detected is determined (step S2302).

At step S2302, detection of setting of the electronic paper 121 on the electronic paper writer 210 is waited for. When setting of the electronic paper 121 is detected (step S2302: YES), the display attribute corresponding to the set writer ID is written to the electronic paper 121 (step S2303).

At step S2303, based on the record read in at step S2301, the display attribute of the writer ID of the electronic paper writer 210 with the electronic paper 121 set thereon is transmitted to the corresponding electronic paper writer 210. The transmitted display attribute is then written by the electronic paper writer 210 to the electronic paper 121 set on the electronic paper writer 210.

Subsequently, a record generated by correlating the participant terminal ID of the electronic paper 121 having a content written thereto with an attribute based on the transmitted display attribute, is set additionally in the participant terminal ID/attribute associated table 1900 (step S2304). The process flow then returns to step S2302, and processes at steps S2303 and S2304 are repeated according to a determination result at step S2302.

In the processing carried out by the content providing system 100 without grouping the electronic papers 121 according to attribute, the processing for identifying the participant attribute greatest in number is carried out after the participant attribute information acquiring/accumulating process depicted in FIG. 23. This processing for identifying the participant attribute greatest in number is identical to the processing for identifying the participant attribute greatest in number depicted in FIG. 20, and is, therefore, omitted in further description.

The content-tied display processing will be described. FIG. 24 is a flowchart (4) of an example of the content-tied display processing. As depicted in the flowchart of FIG. 24, a detail page number is acquired from the detail page number DB 139 (step S2401), and the participant attribute greatest in number table 2100 is read to acquire the participant attribute greatest in number (step S2402).

The participant attribute-type-based content DB 135 is then read to read in the corresponding content files stored in content storage locations correlated with each attribute (step S2403). Subsequently, “N” representing the page number of content displayed by the large presentation screen 110 and the electronic paper 121 is set to “N=1” (step S2404).

Whether “N” is the detail page number acquired at step S2401 is determined (step S2405). If “N” is not the detail page number (step S2405: NO), N-th page data in the corresponding content file is displayed on the electronic paper 121 (step S2406).

At step S2406, records in the participant terminal ID/attribute associated table 1900 are sequentially read to read in an attribute set in a read record, and N-th page data in the content file corresponding to the read attribute is transmitted to the corresponding electronic paper 121. The N-th page data in the transmitted content file is then displayed on the electronic paper 121.

Subsequently, N-th page data in the corresponding content file is displayed on the display unit of the presenter terminal 111 (large presentation screen 110) (step S2407). At step S2407, the N-th page data in the content file corresponding to the participant attribute greatest in number is transmitted to the presenter terminal 111 to display the N-th page data in the transmitted content file on the display unit of the presenter terminal 111 (large presentation screen 110). Steps S2406 and S2407 may be executed in reverse order, in which case step S2406 is executed after executing step S2407.

The operation detecting process by the presenter terminal 111 is then carried out (step S2408), and whether page-turning (new page number) at the presenter terminal 111 has been detected is determined, the new page number being transmitted from the presenter terminal 111 (step S2409). If page-turning (new page number) has been detected (step S2409: YES), the detected new page number is set to “N” (step S2410), after which the process flow returns to step S2405.

If page-turning (new page number) at the presenter terminal 111 has not been detected at step S2409 (step S2409: NO), whether closing operation at the presenter terminal 111 has been detected is determined (step S2411). If the closing operation at the presenter terminal 111 has not been detected (step S2411: NO), the process flow returns to step S2408, where the operation detecting process by the presenter terminal 111 is carried out (step S2408). If the closing operation at the presenter terminal 111 has been detected (step S2411: YES), a series of the processing is ended.

If “N” is the detail page number at step S2405 (step S2405: YES), the N-th page data in the corresponding content file is displayed on the electronic paper 121 (step S2412). At step S2412, the participant terminal ID/attribute associated table 1900 is read, and the N-th page data in the content file corresponding to the attribute of the electronic paper 121 is transmitted to the electronic paper 121 whose participant terminal ID is set in a record for an attribute other than the attribute greatest in number. The N-th page data in the transmitted content file is then displayed on the electronic paper 121.

Subsequently, the N-th page data in the content file corresponding to the participant attribute greatest in number is transmitted to the presenter terminal 111 to display the transmitted N-th page data in the content file on the display unit of the presenter terminal 111 (large presentation screen 110) (step S2413). Steps S2412 and S2413 may be executed in reverse order, in which case step S2412 is executed after executing step S2413.

The detail content information DB 140 is then read to read in the corresponding detail file stored in the content storage location correlated with the participant attribute greatest in number (step S2414). Subsequently, the corresponding detail content is displayed on the electronic paper 121 (step S2415). At step S2415, records in the participant terminal ID/attribute associated table 1900 are sequentially read in, and the detail content corresponding to the attribute of the electronic paper 121 is transmitted to the electronic paper 121 whose participant terminal ID is set in a record for the participant attribute greatest in number. The transmitted detail content is then displayed on the electronic paper 121, after which the process flow proceeds to step S2408 where the operation detecting process by the presenter terminal 111 is carried out.

As described, according the content providing system 100 of the present embodiment, content corresponding to the attribute of each participant may be distributed to the PC 120 or the electronic paper 121 used by each participant corresponding to the progress of the presentation. As a result, in the presentation attended by a multiplicity of unidentified people, the presentation is carried out using content appropriate for each participant to allow each participant to sufficiently understand the contents of the presentation.

Transmission of a content file to the PC 120 is not limited to simultaneous transmission of all the content (pages) making up the content file. For example, portions of one content file may be transmitted, such as half of the file or a given number of pages, through multiple transmissions.

For example, content that does not include the cost of the insurance product is transmitted first to proceed with the presentation when no cost is presented. At a point at the end of a scheduled explanation prepared by the insurance company, content (page) including the cost of the insurance product is transmitted to each PC 120, thereby preventing the participants from losing interest in the presentation as a result of knowing the cost in advance.

In another example, the content of a page used for the presentation is transmitted first and then the content of a page not used at the presentation is transmitted after the conclusion of the presentation, thereby preventing trouble such as the participants becoming confused during the presentation due to the presence of content irrelevant to the progress of the presentation, and further enabling extra content to be provided after the presentation. Participants are thus able to sufficiently understand the contents of the presentation.

For example, when the content providing system 100 according to the embodiment is used at an international convention, the native languages of participating countries may be determined to be attributes so that what is included in content to be provided (native language used in the content) is selected.

According to the content providing system 100 of the present embodiment, the use of the PCs 120 allows participants to input attribute information. Because of this, even for a presentation that is attended by a multiplicity of unidentified participants, where the collection of attribute information before the start of the presentation difficult, on the day of the presentation, content adjusted according to the attributes of each participant in attendance may be distributed. Even for a presentation in which the number of participants and attributes cannot be determined in advance, therefore, the presentation can be carried out using content appropriate for each participant to enable the participants to sufficiently understand the contents of the presentation.

According to the content providing system 100 of the present embodiment, a participant selects the electronic paper 121 (or PC 120) to which an attribute is assigned. This saves the participant trouble of inputting attribute information of the participant, thus allows the presentation to be carried out without imposing a burden on the participant.

According to the content providing system 100 of the present embodiment, use of the highly flexible electronic paper 120 leads a participant to bring home the electronic paper 120 displaying, for example, information that interests the participant most. As a result, the participant is able to thoroughly review the contents of the presentation after the conclusion of the presentation and consider the purchase of an insurance product.

According to the content providing system 100 of the embodiment, page-turning is carried out on the PC 120 and the electronic paper 121 at the same time as the page-turning on the presenter terminal 111 (large presentation screen 110), so that display contents on the electronic paper 121 coincides with the timing of the explanation established by the presenter. As a result, participants are able to listen to the explanation without being left behind as the presentation progresses, and thus are able to sufficiently understand the contents of the presentation.

While a case of the content providing apparatus 130 carrying out the distribution process based on an instruction from the presenter terminal 111 is described in the embodiment, the embodiment is not limited hereto. For example, the function of the presenter terminal 111 and of the content providing apparatus 130 may be implemented together by one apparatus. While a case of carrying out page-turning based on an instruction from the presenter is described, a configuration is possible where an instruction is given to automatically carry out page-turning at given time intervals.

The content providing method explained in the present embodiment may be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program may be distributed through a network such as the Internet.

The content providing apparatus 130 described in the present embodiment may be realized by an application specific integrated circuit (ASIC) such as a standard cell or a structured ASIC, or a programmable logic device (PLD) such as a field-programmable gate array (FPGA). Specifically, for example, functional units of the content providing apparatus 130 are defined in hardware description language (HDL), which is logically synthesized and applied to the ASIC, the PLD, etc., thereby enabling manufacture of the content providing apparatus 130.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium storing therein a content providing program of a content providing system that provides content of a presentation to a participant terminal, the content providing program causing the content providing system to execute:
acquiring attribute information concerning an attribute of a participant using the participant terminal;
extracting, based on the attribute information, content stored in a content database and corresponding to the attribute information; and
transmitting to the participant terminal, based on a page-turning instruction for the content, page information of the content to be displayed on a display screen of the participant terminal.

2. The computer-readable recording medium according to claim 1 and storing therein the content providing program further causing the content providing system to execute:
transmitting the extracted content to the participant terminal before the transmitting of the page information, wherein
the transmitting transmits page-turning instruction information as the page information to be displayed on the display screen of the participant terminal.

3. The computer-readable recording medium according to claim 1 and storing therein the content providing program, wherein
the transmitting transmits portion data of the extracted content corresponding to the page-turning instruction for the content as the page information to be displayed on the display screen of the participant terminal.

4. The computer-readable recording medium according to claim 1 and storing therein the content providing program further causing the content providing system to execute:
identifying, based on the attribute information acquired at the acquiring, an attribute greatest in number among attributes of participants, wherein
the transmitting includes displaying on a screen connected to the content providing system, content correlated with the attribute information concerning the identified attribute.

5. A content providing apparatus of a content providing system that provides content of a presentation to a participant terminal, the content providing apparatus comprising:
an acquiring unit that acquires attribute information concerning an attribute of a participant using the participant terminal;
an extracting unit that, based on the attribute information, extracts content stored in a content database and corresponding to the attribute information; and
a first transmitting unit that transmits to the participant terminal, based on a page-turning instruction for the content, page information of the content to be displayed on a display screen of the participant terminal.

6. The content providing apparatus according to claim 5 and further comprising:
a second transmitting unit that transmits the extracted content to the participant terminal before the first transmitting unit transmits the page information, wherein
the first transmitting unit transmits page-turning instruction information as the page information to be displayed on the display screen of the participant terminal.

7. The content providing apparatus according to claim 5, wherein
the first transmitting unit transmits portion data of the extracted content corresponding to the page-turning instruction for the content as the page information to be displayed on the display screen of the participant terminal.

8. The content providing apparatus according to claim 5 and further comprising:
an identifying unit that, based on the attribute information acquired by the acquiring unit, identifies an attribute greatest in number among attributes of participants, wherein
the first transmitting unit causes content correlated with the attribute information concerning the identified attribute to be displayed on a screen connected to the content providing system.

9. A content providing method of a content providing system that provides content of a presentation to a participant terminal, the content providing method comprising:
acquiring attribute information concerning an attribute of a participant using the participant terminal;
extracting, based on the attribute information, content stored in a content database and corresponding to the attribute information; and
transmitting to the participant terminal, based on a page-turning instruction for the content, page information of the content to be displayed on a display screen of the participant terminal.

10. The content providing method according to claim 9 and further comprising:
transmitting the extracted content to the participant terminal before the transmitting of the page information, wherein
the transmitting transmits page-turning instruction information as the page information to be displayed on the display screen of the participant terminal.

11. The content providing method according to claim 9, wherein
the transmitting transmits portion data of the extracted content corresponding to the page-turning instruction for the content as the page information to be displayed on the display screen of the participant terminal.

12. The content providing method according to claim 9 further comprising:
identifying, based on the attribute information acquired at the acquiring, an attribute greatest in number among attributes of participants, wherein
the transmitting includes displaying on a screen connected to the content providing system, content correlated with the attribute information concerning the identified attribute.
